(19) United States
(12) Patent Application Publication
(10) Pub. No.: US 2022/0110193 A1
(43) Pub. Date: Apr. 7, 2022

(54) CAVITY FOR A MICROWAVE OVEN

(71) Applicant: SOCIETE DES PRODUITS NESTLE S.A., Vevey (CH)

(72) Inventor: Ulrich Johannes Erle, Cleveland, OH (US)

(21) Appl. No.: 17/420,747

(22) PCT Filed: Jan. 6, 2020
(86) PCT No.: PCT/EP2020/050134

§ 371 Date: Jul. 6, 2021

Related U.S. Application Data
(60) Provisional application No. 62/789,222, filed on Jan. 7, 2019.

(51) Int. Cl. H05B 6/68; H05B 6/72

(52) U.S. Cl. CPC H05B 6/686; H05B 6/72; H05B 6/6435; H05B 2206/044; H05B 6/687

(57) ABSTRACT

The invention relates to a cavity (i) for a microwave oven. The cavity (1) comprises: a space (2) for receiving ε food product, at least two solid state microwave sources for generating microwaves, a control unit for controlling the solid state microwave sources, and two microwave emitters (3, 4) for coupling the microwaves (6, 7) generated by the solic state microwave sources into the space (2). The control unit is configured to control the solid state microwave sources such that E standing microwave (5) for providing a zone (51) for heating E food product received by the space (2) is generated between the two microwave emitters (3, 4), and such that the position of the zone (51) with respect to the space (2) is adjustable based on the control. The inventor further relates to ε icrowave emitters 3, 4.

### 1. FIELD OF THE INVENTION

The invention relates to a cavity for a microwave oven, a microwave oven comprising such a cavity, and t method for heating a food product.

### 2. TECHNICAL BACKGROUND

In the prior art, microwave ovens are very common appliances with more than 90% household penetration in the US and comparable numbers in other industrialized countries. Besides the re-heating of leftovers, the preparation of frozen meals and snacks is considered to be the most important use of microwave ovens. The main benefit of microwave ovens is their speed, which is a result of the penetration of the electromagnetic waves into the food products. Although this heating mechanism is sometimes called ‘volumetric heating’, it is important to know that the heating pattern is not very even throughout the volume of the food. In fact, there are several aspects of today's household microwave ovens and their interaction with food that can lead to unsatisfactory results: The vast majority of household microwave ovens have a magnetron as microwave source, because this device is inexpensive and delivers enough power for quick heating. However, the frequency of microwaves from magnetrons is not controlled precisely and may vary between 2.4 and 2.5 GHz (for most household ovens). Consequently, the pattern of high and low intensity areas in the oven cavity is generally unknown and may even vary during the heating process.

Solid State Microwave Technology offers several advantages over magnetron-based technology. The main difference lies in the precise control of the frequency, which is a result of the electronic frequency generator in combination with the solid state amplifier. The frequency is directly related to the heating pattern in the cavity, so a precise frequency control leads to a well-defined heating pattern. In addition, the architecture of e solid state system makes it relatively easy to measure the percentage of microwaves that are being reflected back to the launchers. This feature is useful for scanning the cavity with a frequency sweep and determining which frequency, i.e. pattern, leads to more absorption by the food and which is less absorbed. Multi-channel solid state systems offer additional flexibility in that the various sources can be operated at the same frequency, with the option of user-defined phase angles, or at different frequencies.

Although Solid State Technology enables very defined and reproducible heating patterns, the shape of these patterns is still not easy to predict or control. This is because they are the result of complex interactions of the incoming waves with the food to be heated as well as multiple reflections between the food and the cavity walls. As the food heats up, it changes its dielectric properties, which may lead to a complete flip of the field pattern (mode). Moreover, the shapes of the fields tend to be very convoluted and hard to match with the shape of t food container. Early attempts to use Solid State technology were conducted using retro-fitted microwave cavities, which made it necessary to ‘scan’ the cavities in order to learn something about the fields in relation to the food load or packaging and decide on the next heating steps. The underlying reason for this ‘multi-mode’ cavity design is that in standard household ovens there is a desire to enable many different heating modes in order to achieve—together with the motion of the turntable—a reasonably even heating of the food.

Furthermore, continuous industrial microwave systems are known, where the shape of the field of high microwave intensity is more regular and mostly independent of the frequency of the microwave source. This is achieved by placing two microwave emitters (here: horn antennae), which are connected to the same microwave source (here: magnetron), opposite to each other (top and bottom) so that a pseudo-standing wave results. For providing a shape of the field of high microwave intensity, which is more regular and more independent of the microwave source, DE 31 20 900 A1 describes an idea, according to which two microwave sources oppose each other. In a continuous microwave sterilization process (also known as “MATS process”), this idea was combined with the use of process water, in which the food to be processed is immersed. The water absorbs most of the waves that are not absorbed by the food so that multiple reflections are suppressed. The primary pattern, as determined by the design of the microwave emitters and the frequency, prevails. This design can be classified as ‘mono-mode’. Since the MATS process aims to sterilize food containers, the goal is to heat them fast and evenly. However, targeted preferential heating, e.g. of one compartment in a food package with several compartments, is not desired and not possible.

Frozen prepared meals often come in multi-compartment trays. The food components in the various compartments are usually very different in nature and therefore have different requirements of heating. A common problem is that the amount of energy supplied to each of the compartments does not meet the culinary requirements of the food therein. For instance, the meat component of a meal typically requires more energy than the vegetable component. Since all components need to reach a safe temperature, the vegetable portion is often overcooked. There is clearly a need to provide a more targeted heating effect for the different food components and compartments, respectively.

There are approaches in the prior art for achieving a targeted uneven heating (“zoning”), but they involve a packaging design with areas of different thermal insulation or a susceptor and a procedure to ‘scan’ the cavity in order to find the right microwave frequency. For example, US 2009/0236334 discloses a method involving a scan of the cavity. As the fields are still unknown after scanning the cavity, there is a risk of wrong interpretation of the scanning results and failure to achieve the targeted uneven heating.

It is thus an objective of the present invention to overcome the disadvantages of the microwave ovens known in the prior art. That is, it is in particular an objective of the present invention to heat a food product in a more controlled manner so that a more targeted preferential heating effect for the food product to be heated is achieved, e.g. for a more even defrosting and heating (“zoning”) of the food product.

These and other objects, which become food product in a more controlled manner so that a are solved by the subject-matter of the independent claims. The dependent claims refer to preferred embodiments of the invention.

### 3. SUMMARY OF THE INVENTION

According to a first aspect of the invention, a cavity for a microwave oven comprises: a space for receiving a food product, at least two solid state microwave sources for generating microwaves, a control unit for controlling the solid state microwave sources, and two microwave emitters for coupling the microwaves generated by the solid state microwave sources into the space. The control unit is configured to control the solid state microwave sources such that a standing microwave (a pseudo-standing microwave) for providing a zone for heating a food product received by the space is generated between the two microwave emitters, and such that the position of the zone with respect to the space is adjustable based on the control.

According to the invention, “a zone for heating a food product” is to be understood as a section of the standing microwave, which provides enough electromagnetic field energy for heating the food product to be heated. In particular, said zone extends between two nodes of the standing microwave, wherein the zone does not include the nodes of the standing microwave. Depending on the length of the standing microwave, the standing microwave may provide a plurality of zones. Preferably, the center of the zone lies where a wave crest or through of the standing microwave has its maximum or minimum.

The cavity therefore makes it possible to position or target the zone and, thus, the electromagnetic field energy of the standing microwave with respect to the space and, thus, with respect to the food product received by the space. Thereby, areas of the food product can be targeted with heat in a defined manner, so that for example an area of the food product requiring more heat energy can be preferred over an are requiring less heat energy (higher or lower heat capacity is needed for different products, or cooking needs to be completed for example in meat products, or some products need to be cooked shorter time such as for example vegetables). For example, the zone including a peak of a wave crest/trough of the standing wave may be controlled such that the zone lies in the are, requiring more energy, whereas at the same time E zone including a node of the standing wave lies in the area requiring less energy. As a result, a more targeted preferential heating of the food product is achieved by the cavity. Furthermore, since no or only a small portion of the wave energy reaches the cavity walls, the zone is independent of the cavity walls, thereby minimizing the usual edge overheating of the food product to be heated.

Preferably, the control unit is configured to control the solid state microwave sources such that the phase angle of the microwave emitted by at least one of the microwave emitters changes, thereby adjusting the position of the zone with respect to the space. In other words, the phase angle between the microwaves emitted by the microwave emitters may be changed. The phase angle may be changed by delaying the microwave emitted by the at least one of the microwave emitters. Consequently, in particular the nodes of the standing waves and, thus, the position of the zone for heating the food product are easily adjusted with respect to the space and the food product.

The control unit may be configured to control the solid state microwave sources such that the phase angle of the microwave emitted by the at least one of the microwave emitters changes in a range from 0° to 180°. In other examples, the phase angle changes in a range from 45° to 180° or by 90° or 180°. The increment for changing the phase may be from 1° to 5°.

The microwave emitters may be provided opposite each other. Thus, the standing microwave can be easily obtained. Additionally or alternatively, a first microwave emitter wave crest or through of the standing microwave has its maximum or minimum. microwave emitter of the microwave emitters is positioned at the bottom of the space. As such, the targeted heating may be restricted to the vertical direction only; thereby the electromagnetic field of the standing microwave has horizontal planes of high and low intensities. Furthermore, the cavity including the microwave emitters can be made compact, in particular in the width direction of the cavity. Each of the microwave emitters may be an antenna, e.g., a horn antenna.

The cavity may comprises at least one additional microwave emitter for coupling an additional microwave generated by the solid state microwave sources into the space, wherein the control unit is preferably configured to control the solid state microwave sources such that after a defined time period after the standing microwave is generated, the at least one additional microwave emitter couples the additional microwave generated by the solid state microwave sources into the space for heating a food product received by the space. The at least one additional microwave emitter can effect that parts of the food product, which are difficultly to be reached and heated by the standing microwave (e.g. the edges of the food product), can be heated. Thus, the temperature in the food product to be heated can be more evenly distributed. In a particularly preferred embodiment, the defined time period is at least 120 seconds, preferably at least 240 seconds.

Preferably, the cavity comprises at least two additional microwave emitters. The at least two additional microwave emitters may be provided opposite each other. Therefore, heat in the food product can be distributed more evenly, in particular at the edges of the food product. Additionally or alternatively, the at least one additional microwave emitter may be provided at different position and/or orientation than the at least two microwave emitters and/or laterally with respect to the space. Consequently, even heat distribution in the food product can be further improved. Furthermore, the cavity can be made compact due to the distributed arrangement of the microwave emitters.

The solid state microwave sources may be designed to generate microwaves at a total power which is comprised from 400 W to 1000 W, preferably such that each of the microwave emitters, and preferably each of the at least one additional microwave emitter, is operated with 50 W to 500 W, preferably with 200 W to 250 W.

The space may be designed to adjust the position and/or the orientation of a food product received by the space. Therefore, a further degree of freedom for positioning the zone with respect to the space is provided, thereby achieving an improved targeting of the heat in the food product to be heated. Preferably, the control unit a configured to control the space for adjusting the position and/or the orientation of a food product received by the space.

According to a second aspect of the invention, a microwave oven comprises a cavity as described herein above.

The microwave oven may comprise F user interface functionally connected with the control unit. Thus, a user may easily adapt the control unit and the position of the zone with respect to the space according to the needs of the user.

The user interface may be configured for inputting parameters of the control unit, e.g. a parameter relating to the position of the zone with respect to the space, in particular a parameter relating to the phase angle of at least the microwave emitted by the one of the microwave emitters.

The microwave oven may comprise a door for selectively closing and opening an opening of the cavity. The door particularly provides F protection from the emitted microwaves and from the vapors and splashing grease of the food product.

According to a third aspect of the invention, a method for heating a food product, e.g. with a cavity or a microwave open as described herein above, comprises the following steps: generating microwaves by at least two solid state microwave sources, coupling the microwaves into a space by way of two microwave emitters, controlling the solid state microwave sources for generating a standing microwave between the two microwave emitters, wherein the standing microwave provides a zone for heating a food product received by the space, and controlling the solid state microwave sources for adjusting the position of the zone with respect to the space.

The method may further comprise the method step of changing the phase angle of the microwave emitted by at least one of the microwave emitters, thereby adjusting the position of the zone with respect to the space.

What was said with respect to the cavity and the microwave oven applies likewise to the method.

### 4. DESCRIPTION OF A PREFERRED EMBODIMENT

In the following, the invention is described exemplarily with reference to the enclosed figures, in which

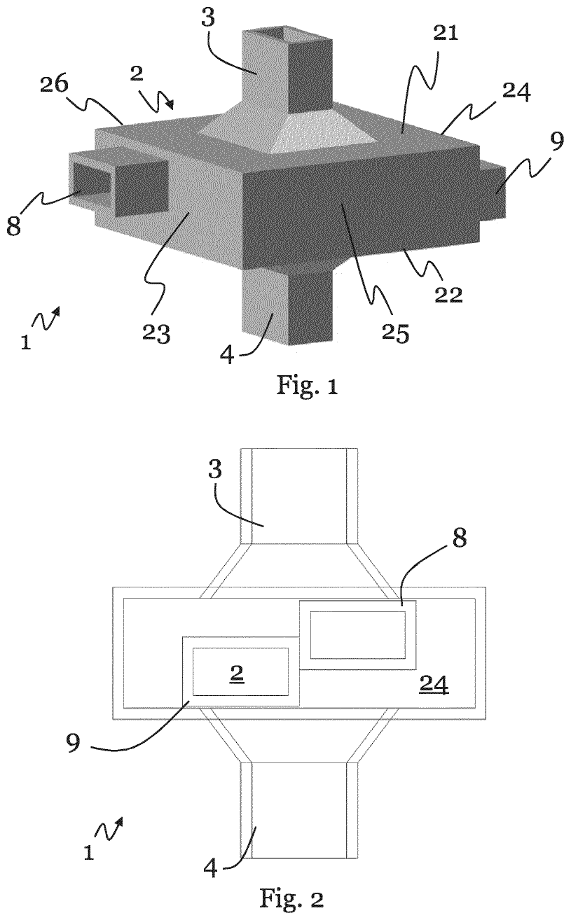

FIG. 1 is a schematic perspective view of a cavity according to a preferred embodiment of the invention,

FIG. 2 is a schematic side view of the cavity shown in FIG. 1,

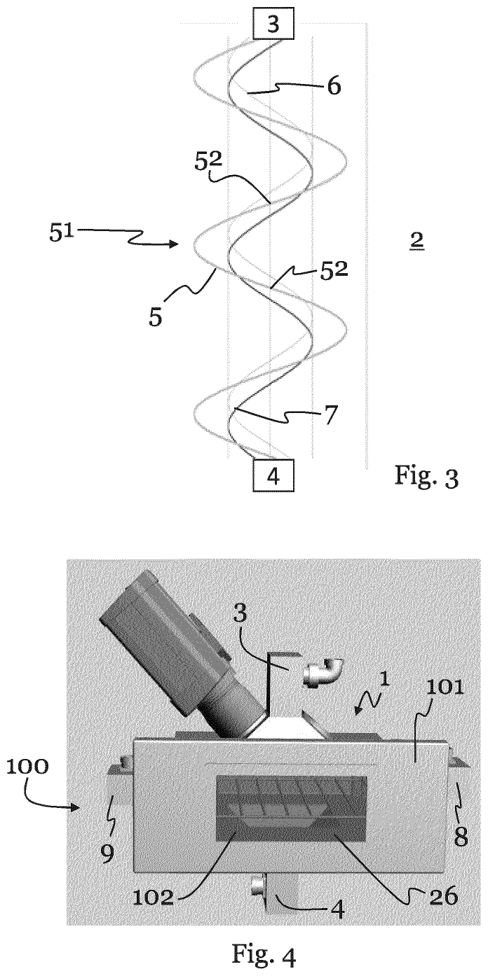

FIG. 3 schematically shows a standing microwave of a preferred embodiment of the cavity according to the invention,

FIG. 4 is a schematic perspective view of a microwave oven according to a preferred embodiment of the invention,

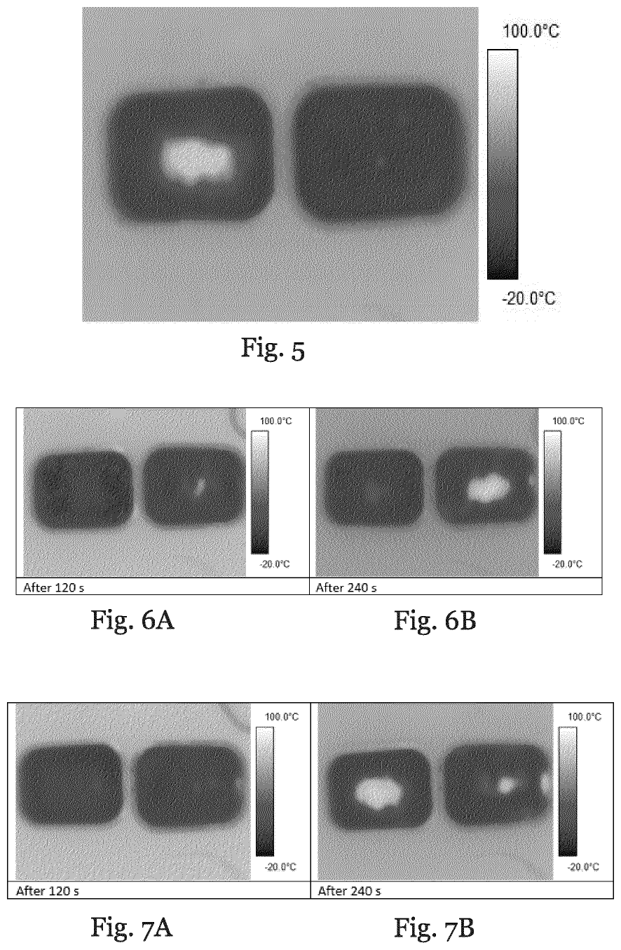

FIG. 5 is a schematic illustration of an infrared image of a first example, which was taken after the first example was heated by a cavity according to a preferred embodiment of the invention,

FIGS. 6A and 6B are schematic illustrations of an infrared image of a second example, which was heated by a cavity according to a preferred embodiment of the invention,

FIGS. 7A and 7B are schematic illustrations of infrared images of a third example, which was heated by a cavity according to a preferred embodiment of the invention,

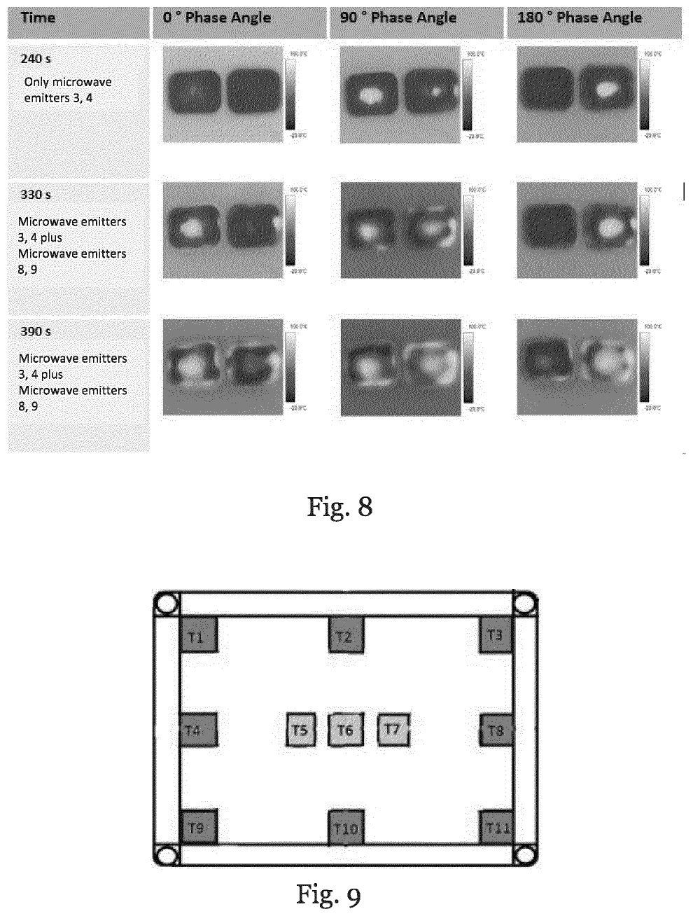

FIG. 8 schematically illustrates infrared images, taken at different phase angles and times, and

FIG. 9 schematically shows the location of temperature readings of a fourth example, which was heated by a cavity according to a preferred embodiment of the invention.

FIG. 1 exemplarily shows a preferred embodiment of a cavity 1 according to the present invention. The cavity 1 is designed to be used in a microwave oven. An exemplarily microwave oven is described below. The cavity 1 comprises a space 2 for receiving a food product. The space 2 may be enclosed by t top wall 21, a bottom wall 22, sidewalls 23, 24 and a back wall 25. The space 2 may be accessible via the food product are easily adjusted back wall 25.

The food product, which can be received by the space 2, may be any packaged or unpackaged food product. The package may be a sealed package. The material of the package may be any material, which is transparent for microwaves. For example, PET may be used as a material of the package. The food product may comprise different components or ingredients (e.g. two or more components or ingredients). The component may have different conditions and/or different culinary qualities. For example, some components may be in a raw condition, whereas other components are in a prepared condition, e.g. already cooked or fried. The components may include carbs (rice, potato, etc.) vegetables, fruits and/or meat. The invention is, however, not limited to specific food components. The components of the food product may have different aggregate conditions, e.g. a frozen or defrosted condition. The package may include different compartments (e.g. two or more compartments), wherein each of the compartments receives a respective component. The compartments may be stacked on each other.

The cavity 1, or the microwave oven described herein below, further comprise: at least two solid state microwave sources (not shown) for generating microwaves. Each of the solid state microwave sources is adapted to generate a respective microwave, having E defined frequency (preferably in a range of 2.4 to 2.5 GHz, most preferably 2.45 GHz), amplitude and phase (angle). However, the process of the invention will work for any frequency, such as 915 MHz for example or other values, frequencies lower than 300 MHz being also possible. In particular, the respective wavelength may be adjusted such that a higher penetration depth and larger spaces of high and low field intensity in the food product to be heated are effected. Each of the solid state microwave sources may comprise a respective electronic frequency generator (synthesizer) and a solid state amplifier for generating the respective microwave. Each of the solid state microwave sources further may comprise a power plug for supplying the solid state microwave source and its components with electric power. Preferably, the at least two solid state microwave sources are operated with a total power which is comprised from 400 W to 1000 W, preferably such that each solid state microwave source is operated with a power from 200 W to 250 W or from 50 W to 500 W.

The cavity 1 further comprises a control unit (not shown) for controlling the solid state microwave sources. In particular, the control unit is adapted to control/adjust the frequency, amplitude and phase of each of the microwaves to be generated by the solid state microwave sources. The control unit may be an electronic control unit, e.g. provided on a computing unit. The control unit may be functionally connected to the solid state microwave sources by wire or wirelessly.

The cavity 1 further comprises two microwave emitters (channels) 3, 4 for coupling the microwaves generated by the solid state microwave sources into the space 2. That is, each of the two microwave emitters 3, 4 comprises a respective solid state microwave source. In some embodiments, each of the microwave emitters 3, 4 is connected to the respective solid state microwave source by way of a cable, e.g. a coax cable, such that the microwaves generated by the solid state microwave sources can be fed into the microwave emitters 3, 4. In other embodiments, coax cables are avoided, e.g. in mass production. The microwave emitters 3, 4 may be provided opposite each other, in particular such that they are directly facing each other. That is, in a plan view of the cavity 1, the microwave emitters 3, 4 may be provided congruently. Preferably, the first microwave emitter 3 is positioned at the top of the space 2, in particular at the top wall 21. The first microwave emitter 3 may be designed integrally with the top wall 21. Alternatively, the first microwave emitter 3 may be detachably connected/fastened to the top wall 21. The second microwave emitter 4 may be positioned at the bottom of the space 2, preferably at the bottom wall 22. The second microwave emitter 4 may be designed integrally with the bottom wall 22. Alternatively, the second microwave emitter 4 may be detachably connected/fastened to the bottom wall 22.

Each of the microwave emitters 3, 4 may be are antenna. The antenna may have a hollow form. Preferably and as car be seen in FIGS. 1 and 2, the antenna is a horn antenna. That is, the antenna may have the form of a horn, wherein the flaring or widening part of the horn antenna opens with its widened opening into the space 2. The microwave emitters 3, 4 may be designed identically.

As schematically shown in FIG. 3, the control unit is configured to control the solid state microwave sources such that a standing microwave 5 for providing a zone 51 for heating a food product received by the space 2 is generated between the two microwave emitters 3, 4. For generating the standing microwave 5, a microwave 6 is emitted from the first microwave emitter 3 and a second microwave 7 is emitted by the second microwave emitter 4. The control unit may control the solid state microwave sources sue that the microwaves 6, 7 emitted by the microwave emitters 3, 4, respectively, are identical with respect to frequency and amplitude, thereby effecting the standing microwave 5. In the preferred embodiment shown in FIGS. 1 and 2, the standing microwave 5 thus extends/propagates in t substantially vertical direction, as exemplarily shown in FIG. 3. In particular depending on the position and orientation of the microwave emitters 3, 4, the orientation of the standing microwave 5 with respect to the space 2 may also be different. That is, the standing microwave 5 may have any direction in the three-dimensional space 2, in particular a horizontal, vertical or inclined extending direction.

As can be seen in FIG. 3, the zone 51 is provided and extends between two nodes 52 of the standing microwave 5. The zone 51 provides enough electromagnetic field energy for heating the food product to be heated. In particular, said zone does not include the nodes 52 of the standing microwave, since there is substantially no electromagnetic field energy at the nodes 52. The zone 51 particularly includes a peak/maximum of a wave crest or through of the standing microwave 5. In other words, the standing microwave 5 includes sections, in which the electric field of the microwave 6 will add to the electric field of the microwave 7, thereby defining the zone 51, whereas in other locations of the standing microwave 5, the microwaves 6, 7 cancel each other, thereby forming the nodes 52. In particular depending on the size of the space 2, the standing microwave 5 may have a length, which provides a plurality of zones 51.

The control unit is further configured to control the solid state microwave sources suck that the position of the zone 51 with respect to the space 2 is adjustable based on the control. In the example shown in FIG. 3, the zone 51 can move up and down with respect to the space 2 based on the control. Having different orientations of the standing microwave 5 inside of the space 2, the zone 51 may also change its position along different directions, in particular along the horizontal or an inclined direction.

Preferably, the control unit is configured to control the solid microwave sources such that the phase angle of the microwave 6, 7 emitted by at least one of the microwave emitters 3, 4 changes, thereby adjusting the position of the zone 51 with respect to the space 2. The control unit may further be configured to control the solid microwave sources such that the phase angle of both microwaves emitted by the microwave emitters 3, 4 change, thereby adjusting the position of the zone 51 with respect to the space 2. Changing the phase angle of the respective microwave may be effected by delaying the respective microwave. For example, by delaying the microwave 7 emitted by the second microwave emitter 4, the position of the zone 51 may be adjusted in a direction towards the second microwave emitter 4, i.e. in a direction downwards in FIG. 3. Correspondingly, by delaying the microwave 6 emitted by the first microwave emitter 3, the position of the zone 51 may be adjusted in a direction towards the first microwave emitter 3, i.e. in a direction upwards 4 changes, thereby adjusting the phase angle of the microwave 6, 7 of at least one of the microwave emitters 3, 4, the zone 51, thus, can reach a position in the space 2 and along the standing microwave 5 between the microwave emitters 3, 4. Therefore, it can be effected that F location in the space 2 or in the food product, which, in a first position of the standing microwave 5, lies within a node of the standing micro wave 5 can, in a second position of the standing microwave 5, lie within the zone 51, in particular in a peak of the standing microwave 5.

The control unit may be configured to control the solid microwave sources such that the phase angle of the microwave emitted by the at least one of the microwave emitters 3, 4 changes in a range from 0° to 180°, preferably in a range from 45° to 180°. The increment of changing the phase angle may be from 1° to 5°. In a particularly preferred embodiment, the phase angle is changed by 90° or 180°.

With the zone 51 having an adjustable position with respect to the space, a food product received by the space 2 can thus be heated in a targeted manner. That is, since the zone 51 has an electromagnetic field energy, which is higher than the electromagnetic field energy of other parts of the standing microwave 5, in particular higher than the electrically field energy of the nodes 52, the standing microwave 5 will preferentially heat a food product where the zone 51 is positioned. By means of the position-adjustable zone 51, an area of the food product requiring more energy (e.g. a first compartment of the food product) can be preferred over an area of the food product requiring less energy (e.g. a second compartment stacked on top of the first compartment). By adjusting the position of the zone 51, the zone 51 can be moved to the respective other area, thereby heating said area (e.g. the second compartment).

The space 2 may be designed to adjust the position and/or the orientation of a food product received by the space 2. As such, the food product may be positioned and orientated by the space 2 in a manner particularly advantageous for heating the food product by the standing microwave 5. Preferably, the space 2 is designed to position a food product such that the food product of a component of the food product is positioned, where the zone 51 of the standing microwave 5 is positioned, when both microwaves 6, 7 have the same phase, e.g. in or near the center of the space 2. For example, compartments or ingredients of the food product may thus be positioned and/or orientated by the space 2 such that by adjusting the position of the zone 51 the zone 51 can easily reach the respective compartments or ingredients. For example, the space 2 may rotatably receive the food product. Additionally or alternatively, the space 2 may comprise structures such as protrusions for positioning the foo product along the extending/propagation direction of the standing microwave 4, e.g. in a vertical and/or horizontal direction of the space 2. The space 2 may be designed to receive a plurality of food product and/or plurality of compartments, e.g. being separated from one another. In a particularly preferred embodiment, the space 2 is designed as a shelf having a plurality of receiving structures such as slots, e.g. five slots, each receiving structure being designed for receiving a food product, in particular a package of E food product. The shelf may comprise longitudinal structures such as wires for receiving the food product, wherein the longitudinal structures are oriented at a 90° angle to the electric field from the standing microwave 5, thereby minimizing any interaction of the shelf with the standing microwave 5. Having the space 2 to be designed to adjust the position and/or the orientation of the food product received by the space 2, the control unit may be configured to control the space 2 for adjusting the position and/or orientation of a food product received by the space. For example, the control unit may control the space 2, e.g. the previously described structures of the space 2, such that the food product changes its position and/or orientation with respect to the extending/propagation direction of the standing microwave 4, e.g. along the vertical and/or horizontal direction.

Turning to FIGS. 1 and 2, the cavity 1 may further comprise at least one additional microwave emitter (additional channel) 8, 9 for coupling an additional microwave generated by the solid state microwave sources, i.e. by an at least one additional solid state microwave source into the space 2, in particular for heating parts of the food product, which can be hardly reached and heated by the zone 51, e.g. the edges of the food product. In some embodiments, the at least one additional microwave emitter 8, 9 is connected to the additional solid state microwave source by way of a cable, e.g. a coax cable, such that the microwave(s) generated by the additional solid state microwave source can be fed into the at least one additional microwave emitter 8, 9. In other embodiments, coax cables are avoided, e.g. in mass production. The at least one additional microwave emitter 8, 9 may be provided at a different position than the at least two microwave emitters 3, 4. In the preferred embodiment shown in FIGS. 1 and 2, the at least one additional microwave emitter 8, 9 is provided laterally with respect to the space 2, e.g. provided at the sidewall 23, 24. The at least one additional microwave emitter 8, 9 may be integrally or detachably connected to the cavity 2 or the respective sidewall 23, 24. The at least one additional microwave emitter 8, 9 is preferably an antenna, which may have a hollow form. For example, the at least one additional microwave emitter 8, 9 may have a cross-section, which is rectangular and/or uniform along the extending direction of the microwave emitter 8, 9.

The cavity 1 may comprise at least two additional microwave emitters 8, 9. That is, besides the first additional microwave emitter 8, the cavity 1 may comprise a further, i.e. second additional microwave emitter y having k further additional solid state microwave source, so that two additional microwaves are coupled into the space 2. The two additional microwave emitters 8, 9 are preferably provided opposite each other, i.e. facing each other. The two additional microwave emitters 8, 9 may be positioned such that the microwave emitted by the first additional microwave emitter 8 can reach locations in the space 2 and, thus, in the food product, which are different from the locations in the space 2 and, thus, in the food product, which the microwave emitted by the second microwave emitter 9 can reach. For example, when viewed in a side view of the cavity 1 as shown in FIG. 2, which is a viewing direction being perpendicular to the side walls 23, 24, the microwave emitters 8, 9 are provided not congruently to each other, but displaced in a horizontal and/or vertical direction to one another, preferably such that the microwave emitters 8, 9 do not overlap each other. The additional microwave emitters 8, 9 may alternatively be also positioned to one another according to the microwave emitters 3, 4, such that the a further standing microwave is generated between the additional microwave emitters 8, 9; what was said with respect to the microwave emitters 3, 4 and the standing microwave 5 thus may apply correspondingly to the microwave emitters 8, 9 and their standing microwave. Therefore, besides the zone 51 a further zone corresponding to the zone 51 may be provided, thereby enhancing the ability of the cavity with respect to targeted heating. Also more than two additional microwave emitters 8, 9 may be used, e.g. three or four additional microwave emitters 8, 9.

The control unit is preferably configured to control the solid state microwave sources such that after a defined time period after the standing microwave 5 is generated, the at least one additional microwave emitter 8, 9 (begins to) couple microwaves generated by the additional solid state microwave source into the space 2 for heating a food product received by the space 2. The microwave(s) er peak of the standing microwave 5. microwave emitter 8, 9 may be substantially perpendicular to the standing microwave 5, e.g. extending in a horizontal direction of the space 2. The defined time period may be set to be at least 120 seconds, preferably at least 240 seconds. The defined time period may be also set differently, e.g. such that when a predefined temperature in the food product has been reached by the zone 51, the at least one microwave emitter 8, 9 starts to couple microwaves into the space 2. Preferably, the control unit is configured to control the solid state microwave sources such that after a total duration of 390 seconds from the beginning, when the microwave emitters 3, 4 started to couple microwaves into the space 2, the microwave emitters 3, 4 and the additional microwave emitters 8, 9 stop coupling microwaves into the space 2.

FIG. 4 exemplarily shows a preferred embodiment of a microwave oven 100 comprising the previously described cavity 1. The microwave oven 100 may comprise a door 101 for selectively closing and opening the opening 26 of the cavity 1. In particular, the door 101 is designed for shielding against the escape of microwaves from the space 2 and/or for shielding against the escape of vapors and splashed greases. The door 101 may comprise a window portion 102 through which can be seen for seeing/observing the space 2 and the food product received by the space 2.

The microwave oven 10o may comprise a user interface (not shown) functionally connected with the control unit. The user interface may facilitate inputting parameters of the control unit, which, in particular, relate to adjusting the position of the zone 51 with respect to the space 2. Such parameters may include a parameter relating to the phase of the at least one of the microwaves 6, 7 emitted by the microwave emitters 3, 4 and, if present, of the microwaves emitted by the at least one additional microwave emitters 8, 9. The parameters may also include the frequency and/or the amplitude of the respective microwave 6, 7 and, if present, of the microwave(s) emitted by the at least one additional microwave emitter 8, 9. The parameters may also include the previously described defined time period, after which the at least one additional microwave emitter 8, S couples microwaves into the space 2. That is, by means of the user interface, the user may also define when the at least one additional microwave emitter 8, 9 should begin to couple the additional microwave(s) into the space 2. The user interface may further be configured to switch on and off the microwave over 100 and cavity 1, respectively.

Due to the rise in the dielectric loss factor when heating a food product, e.g. with stacked compartments, there may be a moment when the part of the food product, e.g. a specific compartment, which is targeted by the zone 51 becomes so absorptive that it no longer transmits sufficient energy for the standing wave 5 to occur. This can be detected by the cavity 1 through a measurement of the transmission from one microwave emitter 3 to the other microwave emitter 4 and vice versa. These values are called ‘S-parameters’. When the sum of transmitted microwave power, e.g. from top to bottom and bottom to top, reaches a threshold value (approx. 10%), it is advisable to switch the heating mode. At this point, the design of the cavity 1 shows another benefit, which is called ‘direct heating’. Since one part (compartment) of the food product now absorbs nearly all the power coming from the nearest microwave emitter, the ensuing heating of that part can simply be controlled by choosing the power level for the corresponding microwave emitter. Here it has to be taken into account that some additional power may come from the opposite side, where the compartment is still colder and does not yet absorb all power.

In the following, experiments conducted with a preferred embodiment of the cavity 1 are described.

In a first example, which is shown in FIG. 5, two identical PET trays (dimensions: 148 mm×106 mm×19 mm) were each filled with 172 g (+/−1%) of mashed potato, resulting in a food layer of approx. 10 mm thickness. The trays were sealed with a polyester film and frozen overnight at −18° C. The frozen samples were taken out of the freezer and stacked in the space 2 so that one tray was placed exactly on top of the other. The stack was placed in the center of a shelf designed with the space 2 of the cavity 1. The shelf has five slots, wherein the second slot from the bottom has been used.

The food was heated in one step of 240 s according to the following table. Each (active) microwave emitter was operated at 2,450 MHz. The phase angle set point between the microwave emitters 3, 4 was 0°. It should be noted that this set point refers to the phase angle coming out of the amplifier of the solid preferred embodiments of the invention angle in the cavity may deviate, for instance due to a difference in the cable length.

| | | Microwave | Microwave | Microwave | Microwave |
|---|---|---|---|---|---|
| | | emitter 4 | emitter 9 | emitter 3 | emitter 8 |
| Step | Duration | (bottom) | (left) | (top) | (right) |
| 1 | 240 s | 200 W tt | 0 Watt | 200 Watt | 0 Watt |

Temperature readings were performed with a thin tip thermocouple at approx. 5 mm depth of the food layer. All temperatures are given in ° C. A value of zero means that the probe could not enter, because the material was still frozen. The corresponding temperatures at different locations were as follows:

| | | | | | | | | | | | |
|---|---|---|---|---|---|---|---|---|---|---|---|
| Step | T1 | T2 | T3 | T4 | T5 | T6 | T7 | T8 | T9 | T10 | T11 |

Top tray

| | | | | | | | | | | |
|---|---|---|---|---|---|---|---|---|---|---|
| 1 | 0 | 0 | 0 | 0 9 | 18 7 | 25 2 | 17 3 | 0 | 0 | 0 |

Bottom tray

| | | | | | | | | | | | |
|---|---|---|---|---|---|---|---|---|---|---|---|
| 1 | 0 | 0 | 0 | 0 | 9 | 0 | 0 | 0 | 0 | 0 | 0 |

One can see that with the cavity a standing microwave 5 could be generated, wherein the zone 51 of the standing microwave 5 could be positioned such that the zone 51 substantially only heats the top tray. The bottom tray is substantially not heated, because the nodes of the standing microwave 5 or a range about said nodes could not provide enough electromagnetic energy for heating. That is, the standing wave 5 had a higher specific food components. The components of the food product may have different infrared image, which was taken after the heating (top tray on the left, bottom tray on the right).

In a second example, which is shown in FIGS. 6A and 6B, two identical PET trays (dimensions: 148 mm×106 mm×19 mm) were each filled with 172 g (+/−1%) of mashed potato, resulting in a food layer of approx. 10 mm thickness. The trays were sealed with a polyester film and frozen overnight at −18° C. The frozen samples were taker out of the freezer and stacked in the space 2 so that one tray was placed exactly on top of the other.

The stack was placed in the center of the space 2, i.e. in a shelf of the space 2 of the experimental microwave cavity, using the second slot from the bottom (out of five slots).

The food was heated in several steps according to the following table. Each microwave emitter was operated at 2,450 MHz. The phase angle set point between the top and bottom microwave emitter was 180°. It should be noted that this set point refers to the phase angle coming out of the amplifier. The true phase angle in the cavity may deviate, energy (higher or lower heat capacity is needed

| | | Microwave | | Microwave | | Microw ve | Microwave |
|---|---|---|---|---|---|---|---|
| | | emitter 4 | | emitter 9 | | emitter 3 | emitter 9 |
| Step | Dur tion | (bottom) | | (left) | | (top) | (left) |
| 1 | 120 s | 250 | W tt | 0 | W tt | 250 Watt | tt |
| 2 | 120 s | 250 | Watt | 0 | Watt | 250 Watt | 0 Watt |

Temperature readings were performed with a third tip thermocouple at approx. 5 mm depth of the food layer. All temperatures are given in ° C. A value of zero means that the probe could not enter, because the material was still frozen. The location of the temperature readings were the same as it the first example above. The corresponding temperatures were as follows:

| | | | | | | | | | | | |
|---|---|---|---|---|---|---|---|---|---|---|---|
| Step | T1 | T2 | T3 | T4 | T5 | T6 | T7 | T8 | T9 | T10 | T11 |

Top tray

| | | | | | | | | | | | |
|---|---|---|---|---|---|---|---|---|---|---|---|
| 1 | 0 | 0 | 0 | 0 | 0 | 0 | | 0 | 0 | 0 | 0 |
| 2 | 0 | 0 | 0 | 0 | 1 | 1 2 | 0 | 0 | 0 | 0 | 0 |

Bottom tray

| | | | | | | | | | | | |
|---|---|---|---|---|---|---|---|---|---|---|---|
| 1 | 0 | 0 | 0 | 0 | 0 | 6 | 0 | 0 | 0 | 0 | 0 |
| 2 | 0 | 0 | 0 2 | 0 | 29 5 | 4 5 | 32 | 0 | 0 | 0 | 0 |

One can see that with the used cavity a standing microwave 5 could be generated, wherein the zone 51 of the standing microwave 5 could be positioned suck that the zone 51 substantially only heats the bottom tray. The top tray is substantially not heated, because the nodes of the standing microwave 5 or a range about said nodes could not provide enough electromagnetic energy for heating. That is, the standing wave 5 had a higher intensity in the bottom tray than in the top tray. This was the result of the phase angle, which was set to 180° in this example. By changing the phase angle from 0° to 180°, the user can choose to heat the bottom tray instead of the top tray. FIGS. 6A and 6B show the corresponding infrared images, which were taken after 120 s and 240 s of heating, respectively (top tray on the left, bottom tray on the right).

In a third example, which is shown in FIGS. 7A and 7B, two identical PET trays (dimensions: 148 mm×106 mm×19 mm) were each filled with 172 g (+/−1%) of mashed potato, resulting in a food layer of approx. 10 mm thickness. The trays were sealed with a polyester film and frozen overnight at −18° C. The frozen samples were taken out of the freezer and stacked it the space 2 so that one tray wat placed exactly or top of the other. The stack was placed in the center of a shelf of the space 2 of the experimental microwave cavity, using the second slot from the bottom (out of five slots).

The food product was heated in several steps according to the following table. Each microwave emitter was operated at 2,450 MHz. The phase angle set point between the microwave emitters 3, 4 was 90°. It should be noted that this set point refers to the phase angle coming out of the amplifier. The true phase angle in the cavity may deviate, for instance due to a difference in cable length.

| | | Microwave | Microwave | Microwave | | Microwave |
|---|---|---|---|---|---|---|
| | | emitter 4 | emitter 8 | emitter 3 | | emitter 8 |
| Step | Dur tion | (bottom) | (right) | (top) | | (right) |
| 1 | 120 s | 250 Watt | 0 Watt | 250 | W tt | 0 Watt |
| 2 | 120 s | 250 Watt | 0 Watt | 250 | Watt | 0 Watt |

Temperature readings were performed with a thin tip thermocouple at approx. 5 mm depth. All temperatures are given in ° C. A value of zero means that the probe could not enter, because the material was still frozen. The location of the temperature readings were the same as in the first example. The corresponding temperatures were as follows:

| | | | | | | | | | | | |
|---|---|---|---|---|---|---|---|---|---|---|---|
| Step | T1 | T2 | T3 | T4 | T5 | T6 | T7 | T8 | T9 | T10 | T11 |

Top tray

| | | | | | | | | | | | |
|---|---|---|---|---|---|---|---|---|---|---|---|
| 1 | 0 | 0 | 0 | 0 | 0 | 0 | 0 | 0 | 0 | 0 | 0 |
| 2 | 0 | 0 | 0 | 0 | 9 5 | 33 6 | 28 1 | 0 | 0 | 0 | 0 |

Bottom tray

| | | | | | | | | | | | |
|---|---|---|---|---|---|---|---|---|---|---|---|
| 1 | 0 | 0 | 0 | 0 | 0 | 0 | 0 | 0 | 0 | 0 | 0 |
| 2 | 0 | 0 | 0 | 8 | 16 5 | 22 9 | 14 4 | 0 | 0 | 0 6 | 0 |

One can see that with the used cavity a standing microwave 5 could be generated, wherein the zone 51 of the standing microwave 5 could be positioned without clear preference for any of the trays. This was the result of the phase angle, which was set to 90° in this example. FIGS. 7A and 7B show the corresponding infrared images, which were taken after 120 s and 240 s of heating, respectively (top tray on the left, the bottom tray on the right).

FIG. 8 shows a fourth example, in which the additional microwave emitters 8, 9 were used. In the first 240 s of heating, the microwave emitters 3, 4 were used only. The trays on infrared image, which was taken after the heating (top tray on the left, bottom phase angle, a hot spot in the middle of the top tray developed. At 180° phase angle, the bottom tray heated up first. At the in-between setting of 90°, both trays heated approximately the same. After the 240 s of heating with the microwave emitters 3, 4 only, the additional microwave emitters 8, 9 were used to complete the heating. (ne can see that with the additional microwave emitters 8, 9 a more even distribution of temperature in the respective food product could be achieved.

FIG. 9 relates to E fifth example, in which a standard microwave oven (standard Sharp Carousel microwave) with a magnetron was used as a benchmark. The trials were conducted with trays containing 500 g of frozen Alfredo sauce. A total of 33 points were measured after the tests, 11 in each depth (5 mm, 13.5 mm, and 22 mm), see FIG. 9.

In the standard microwave oven, the target time was set between 5 and 6 min, meaning that all parts of the container had to react a temperature of 0° C. or greater in order for the defrosting to be complete.

The power setting needed to fulfill the time limit in the standard microwave oven was 60% (nominally 660 Watts). The tray was placed off-center, as this is known to alleviate the problem of a possible hot or cold center spot in the middle of the turntable. As expected, the resulting heating pattern was very uneven. The edges started to heat first, reaching up to 80.4° C. At this point in time, which was chosen as it was the first moment, when complete defrosting was detected, the coldest spot was at 3.9° C.

The cavity 1 according to a preferred embodiment of the invention, i.e. microwave oven according to a preferred embodiment of the invention, delivered a more favorable result. There was a stronger heating in the center than at the edges. The use of the additional microwave emitters 8, 9 were used to compensate for the center heating, leading to are improved overall temperature profile. The maximum of all measured spots was 30.9° C., and the minimum was 0.5° C. The infrared camera revealed that two corners were closer to 50° C., but this was so near the rim of the packaging that it could not be captured by the probing.

It should be clear to a skilled person that the embodiment shown in the figures is only F preferred embodiment, but that, however, also other designs of a cavity 1 can be used.

1. Cavity for a microwave oven, comprising
a space for receiving a food product,
at least two solid state microwave sources for generating microwaves,
a control unit for controlling the solid state microwave sources, and
two microwave emitters for coupling the microwaves generated by the solid state microwave sources into the space,
wherein the control unit is configured to control the solid state microwave sources such that
a standing microwave for providing a zone for heating a food product received by the space is generated between the two microwave emitters, and
the position of the zone with respect to the space is adjustable based on the control.

2. Cavity according to claim 1, wherein the control unit is configured to control the solid state microwave sources such that the phase angle of the microwave emitted by at least one of the microwave emitters changes, thereby adjusting the position of the zone with respect to the space.

3. Cavity according to claim 1, wherein the microwave emitters are provided opposite each other, and/or wherein a first microwave emitter of the microwave emitters is positioned at the top of the space, wherein a second microwave emitter of the microwave emitters is positioned at the bottom of the space.

4. Cavity according to claim 1, wherein each of the microwave emitters is an antenna.

5. Cavity according to claim 1, wherein the cavity comprises at least one additional microwave emitter for coupling an additional microwave generated by the solid state microwave sources into the space, and
wherein the control unit is preferably configured to control the solid state microwave sources such that after a defined time period after the standing microwave is generated, the at least one additional microwave emitter couples an additional microwave generated by the solid state microwave sources into the space for heating a food product received by the space, wherein the defined time period is preferably at least 120 s, more preferably at least 240 s.

6. Cavity according to claim 5, wherein the cavity comprises at least two additional microwave emitters, wherein the at least two additional microwave emitters are preferably provided opposite each other.

7. Cavity according to claim 5, wherein the at least one additional microwave emitter is provided at a different position and/or orientation than the at least two microwave emitters and/or laterally with respect to the space.

8. Cavity according to claim 1, wherein the solid state microwave sources are designed to generate microwaves at a total power which is comprised from 400 Watt to 1000 Watt.

9. Cavity according to claim 1, wherein the space is designed to adjust the position and/or the orientation of a food product received by the space, and wherein the control unit is preferably configured to control the space for adjusting the position and/or the orientation of a food product received by the space.

10. Microwave oven comprising a cavity comprising a space for receiving a food product, at least two solid state microwave sources for generating microwaves, a control unit for controlling the solid state microwave sources, and two microwave emitters for coupling the microwaves generated by the solid state microwave sources into the space, wherein the control unit is configured to control the solid state microwave sources such that a standing microwave for providing a zone for heating a food product received by the space is generated between the two microwave emitters, and the position of the zone with respect to the space is adjustable based on the control.

11. Microwave oven according to claim 10, wherein the microwave oven comprises a user interface functionally connected with the control unit.

12. Microwave oven according to claim 11, wherein the user interface is configured for inputting parameters of the control unit.

13. Microwave oven according to claim 10, wherein the microwave oven comprises a door for selectively dosing and opening an opening of the cavity.

14. Method for heating a food product, the method comprising:
generating microwaves by at least two solid state microwave sources,
coupling the microwaves into a space by way of two microwave emitters, controlling the solid state microwave sources for generating a standing microwave between the two microwave emitters, wherein the standing microwave provides a zone for heating a food product received by the space, and
controlling the solid state microwave sources for adjusting the position of the zone with respect to the space.

15. Method according claim 14, comprising the step of changing the phase angle of the microwave emitted by at least one of the microwave emitters, thereby adjusting the position of the zone with respect to the space.
